(19) United States
(12) Patent Application Publication
(10) Pub. No.: US 2024/0392398 A1
(43) Pub. Date: Nov. 28, 2024

(54) METHOD FOR REFINING MOLTEN IRON

(71) Applicant: Industry-Academic Cooperation Foundation, YONSEI UNIVERSITY, Seoul (KR)

(72) Inventors: Gyo Khang PARK, Seoul (KR); Il SOHN, Seoul (KR)

(21) Appl. No.: 18/672,790

(22) Filed: May 23, 2024

(30) Foreign Application Priority Data
May 23, 2023 (KR) 10-2023-0066586

(51) Int. Cl. C21B 13/00; C21B 13/12

(52) U.S. Cl. CPC C21B 13/008; C21B 13/0006; C21B 13/0073; C21B 13/12; C21B 2100/40

(57) ABSTRACT

An embodiment provides a method and a system device for refining molten iron, wherein hydrogen reduction DRI is utilized to collect CO₂ gas generated during melting and further reduction and use the gas in decarbonization refining, so as to optimize processes and achieve carbon neutrality. In addition, it is possible to predict the end point of the decarbonization refining by measuring the amount of CO gas generated in decarbonization refining.

### CROSS-REFERENCE TO RELATED APPLICATION(S)

This application claims priority to Korean Patent Application No. 10-2023-0066586, filed on May 23, 2023, the entire disclosure of which is incorporated herein for all aspects.

### BACKGROUND

The disclosure relates to a method for refining molten iron and, more specifically, to a method for performing decarbonization refining using CO₂ gas generated in a Direct Reduction Iron (DRI) process and a melting process.

The world is conducting various research activities to achieve so-called carbon neutrality, which is to reduce carbon emissions as much as possible and increase absorption to reduce actual carbon emissions to “0” level. In order to respond to the implementation of carbon neutrality and establishment of related policies in countries around the world, various policies and strategies are being implemented domestically, and in particular, a special solution is needed as greenhouse gas emissions in the steel sector correspond to the highest emissions with reference to a single industry.

In the case of a hydrogen reduction steelmaking technology, which has recently been attracting attention as a decarbonization technology, the development has been made focusing on the production of hydrogen-reduced iron based on high-grade raw materials (DR-grade) with an iron (Fe) content of 67% or more and the electric arc furnace (EAF) melting process. However, high-quality raw materials account for a very small proportion of the total raw material supply, and due to concerns about limited supply and demand, the development of a technology for utilizing low-quality raw materials has become an issue.

Therefore, when using low-quality raw materials, problems such as a reduced reduction rate and a decreased yield due to increased gangue content are anticipated, and thus a plan to introduce hydrogen reduction direct reduction iron (DRI) and Electric Smelter (melting+implementation of further reduction by carbon material+carbon capture, utilization, and storage (CCUS) linkage) instead of the electric furnace schemes are being considered. In this case, CO₂ or the like generated by the use of carbon reducing agents in a smelter process is highly likely to be recycled (CCU) in a decarbonization reaction, and thus there is a need for research using CO₂.

In conventional O₂ refining, CO gas is no longer generated at the end of decarbonization refining (2Fe+O₂→2FeO). However, in CO₂ refining, even if decarbonization refining ends, CO gas continues to be generated during an oxidation process of metals such as Fe by CO₂ gas, making it difficult to predict the end of decarbonization at a location at which CO gas generation stops (Fe+CO₂→FeO+CO).

### SUMMARY

The disclosure is to provide a method and a system device for refining molten iron, wherein CO₂ gas generated during melting and further reduction is collect to be used in decarbonization refining, so as to optimize processes and achieve carbon neutrality.

In addition, the disclosure is to predict the end point of the decarbonization refining by measuring the amount of CO gas generated in decarbonization refining.

The aspect of the disclosure is not limited to that mentioned above, and other aspects not mentioned will be clearly understood by those skilled in the art from the description below.

According to an embodiment of the disclosure, provided is a method for refining molten iron using hydrogen reduction DRI, the method including: preparing a raw material; reducing the raw material through a Direct Reduction Iron (DRI) process; inputting a carbon material into the reduced raw material to perform melting and further reduction; separating and collecting CO₂ gas from exhaust gas generated according to the input of the carbon material; performing decarbonization refining by blowing the separated and collected CO₂ gas into molten iron; and determining whether decarbonization refining is complete by measuring the amount of CO gas generated in the decarbonization refining.

The melting and further reduction may be performed through electric smelting (electric smelter).

The separating and collecting of the CO2 gas may be performed through physical adsorption or chemical absorption.

The separating and collecting of the CO2 gas may further include collecting CO2 and O2 mixed gas.

The determining of whether the decarbonization refining is complete may be achieved based on a location at which a reduction behavior of a CO gas generation amount occurs.

The determining of whether the decarbonization refining may further include performing further refining if the decarbonization refining is completed, and performing the decarbonization refining again if the decarbonization refining is not completed.

According to another embodiment of the disclosure, provided is molten iron from the refining of molten iron using hydrogen reduction DRI.

According to another embodiment of the disclosure, provided is a system device for refining molten iron using hydrogen reduction DRI, the system device including: a raw material input unit for inputting a raw material; a raw material reduction unit that reduces the raw material; a melting unit that melts and further reduces the reduced raw material; a collecting unit that separates and collects CO2 gas from exhaust gas generated by the melting and further reduction; a decarbonization refining unit that performs decarbonization refining by blowing the separated and collected CO2 gas into molten iron; and a measuring unit that measures the amount of CO gas generated during the decarbonization refining.

The raw material reduction unit may reduce a raw material through a Direct Reduction Iron (DRI) process.

The melting unit may be performed through electric smelting (electric smelter).

The measuring unit may measure the amount of CO gas generated in decarbonization refining and determine the end time of decarbonization.

According to an embodiment of the disclosure, it is possible to achieve process optimization and carbon neutrality by collecting CO₂ gas generated from an electric smelter during melting and blowing the gas into molten iron during decarbonization refining.

This technology is intended to be applied to a process of refining carbon and impurities through CO₂ gas blowing to realize a carbon-neutral future steelmaking technology, rather than a process of refining carbon and impurities by blowing O₂ gas into molten iron in a general steelmaking process, and it is possible to predict the end of decarbonization refining by observing the amount of CO gas generated due to CO₂ gas blowing.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flow chart showing a method for refining molten iron using hydrogen reduction DRI of the disclosure;

FIG. 2 is a graph of a result of a Factsage program for O₂ gas blowing;

FIG. 3 is a graph of a result of a Factsage program for CO₂ gas blowing;

FIG. 4 is a schematic diagram of a vertical tubular furnace experiment used in an embodiment of the disclosure; and

FIG. 5 is a graph of a gas analyzer analysis result in a vertical tube furnace for CO₂ gas blowing.

### DETAILED DESCRIPTION

Hereinafter, the disclosure will be described with reference to the accompanying drawings. However, the disclosure may be implemented in various different forms and, therefore, is not limited to the examples described herein. In order to clearly explain the disclosure in the drawings, portions unrelated to the description are omitted, and similar portions are given similar reference numerals throughout the specification.

Throughout the specification, when a portion is said to be “connected (linked, contacted, combined)” with another portion, this includes not only a case of being “directly connected” but also a case of being “indirectly connected” with another member in between. In addition, when a portion is said to “include” a certain component, this does not mean that other components are excluded, but that other components may be added, unless specifically stated to the contrary.

The terms used herein are merely used to describe specific embodiments and are not intended to limit the disclosure. Singular expressions include plural expressions unless the context clearly dictates otherwise. In this specification, it should be understood terms such as “include” or “have” are to designate the presence of features, numbers, steps, operations, components, parts, or combinations thereof described in the specification, but are not to exclude in advance the possibility of the presence or addition of one or more other features, numbers, steps, operations, components, parts, or combinations thereof.

Hereinafter, embodiments of the disclosure will be described in detail with reference to the accompanying drawings.

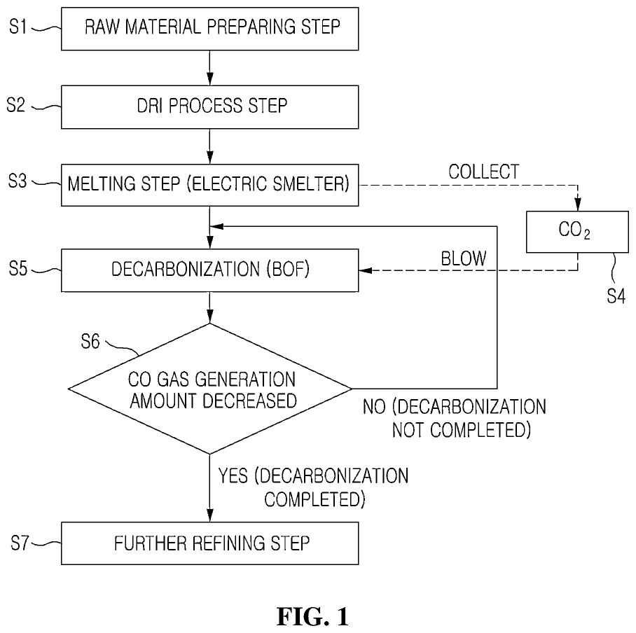

FIG. 1 is a flow chart showing a method for refining molten iron using hydrogen reduction DRI of the disclosure.

Referring to FIG. 1, a method of refining molten iron using hydrogen reduction DRI according to an embodiment of the disclosure will be described.

According to an embodiment of the disclosure, a method for refining molten iron using hydrogen reduction DRI may include: (S1) preparing a raw material; (S2) reducing the raw material through a Direct Reduction Iron (DRI) process; (S3) inputting a carbon material into the reduced raw material to perform melting and further reduction; (S4) separating and collecting CO₂ gas from exhaust gas generated according to the input of the carbon material; (S5) performing decarbonization refining by blowing the separated and collected CO₂ gas into molten iron; and (S6) determining whether decarbonization refining is complete by measuring the amount of CO gas generated in the decarbonization refining.

The first step is S1, which is preparing a raw material. In S1, low-grade raw materials (Fe content less than 67%) are prepared. High-quality raw materials account for a very small proportion of the total raw material supply, and due to concerns about limited supply and demand thereof, research is being conducted on ways to utilize low-quality raw materials, lower a reduction rate, reduce a yield due to increased gangue content, and the like.

The next is S2, which is reducing the raw material through a Direct Reduction Iron (DRI) process. A DRI process is a technology that produces iron sources by reducing iron ore in a solid state using reducing gas (CO, H). The raw material prepared in S1 is directly reduced through a DRI process in S2. When conventional high-grade raw materials are used, the amount of unreduced iron oxide after a DRI process is small, but when low-grade raw materials are used, the amount of unreduced iron oxide is large, which increases electricity consumption and the amount of slag. Therefore, in addition to a DRI process, it is necessary to perform melting and further reduction on input carbon materials such as coke in an electric smelter.

The next is S3, which is inputting a carbon material into the reduced raw material to perform melting and further reduction. S3 may be performed through electric smelting (electric smelter). When using low-quality raw materials, in order to solve problems such as a reduced reduction rate and a decreased yield due to an increased gangue content, hydrogen reduction direct reduction iron (DRI) and Electric Smelter (melting+implementation of further reduction by carbon material+carbon capture, utilization, and storage (CCUS) linkage) schemes instead of the electric furnace scheme are utilized. In this case, CO₂ or the like generated by the use of carbon reducing agents in an electric smelter process is likely to be reused in a decarbonization refining reaction, and thus CO₂ gas should be separately collected for use.

The next is S4, which is separating and collecting CO₂ gas from exhaust gas generated according to the input of the carbon material. S4 may be performed by physical adsorption or chemical absorption. However, the scheme is not limited thereto.

S4 may further include collecting CO₂ and O₂ mixed gas. In the decarbonization refining, O₂ refining is possible in addition to CO₂ refining. In conventional O₂ refining, CO gas is no longer generated at the end of decarbonization refining.

The next is S5, which is performing decarbonization refining by blowing the separated and collected CO₂ gas into molten iron. When separated and collected CO₂ gas is input and undergoes decarbonization refining, CO gas is generated. After carbon and impurities are removed, CO₂ gas oxidizes Fe to produce FeO and Fe₂O₃, and CO gas continues to be generated.

The next is S6, which is determining whether decarbonization refining is complete by measuring the amount of CO gas generated in the decarbonization refining. S6 may be achieved based on a location at which a reduction behavior of a CO gas generation amount occurs. In conventional O₂ refining, CO gas is no longer generated at the end of decarbonization refining (2Fe+O₂→2FeO). However, in CO2 refining, even if decarbonization refining ends, CO gas continues to be generated during an oxidation process of metals such as Fe by CO2 gas, making it difficult to predict the end of decarbonization at a location at which CO gas generation stops (Fe+CO2→FeO+CO). Accordingly, it is possible to confirm that when refining is performed by blowing CO₂ gas rather than O₂ gas, a location at which the amount of CO gas generated changes, not a location at which CO gas generation stops, is a point at which decarbonization refining ends.

S6, which is determining whether decarbonization refining is complete, performs further refining (S7) if the decarbonization refining is completed, and re-performs S5, which is decarbonization refining, if the decarbonization refining is not completed. It is possible to efficiently refine molten iron by predicting the end time of decarbonization refining of molten iron from changes in the concentration of CO gas generated.

Hereinafter, molten iron according to another embodiment of the disclosure will be described.

Molten iron according to an embodiment of the disclosure may include molten iron refined according to said method for refining molten iron using hydrogen reduction DRI. Molten iron that has gone through a DRI process has fewer impurities and may be used as a substitute for high-quality steel scrap. After carbon and impurities are removed, CO₂ gas oxidizes Fe to produce FeO and Fe₂O₃.

Hereinafter, a system device for refining molten iron using hydrogen reduction DRI according to another embodiment of the disclosure will be described.

According to an embodiment of the disclosure, a system device for refining molten iron using hydrogen reduction DRI may include: a raw material input unit for inputting a raw material; a raw material reduction unit that reduces the raw material; a melting unit that melts and further reduces the reduced raw material; a collecting unit that separates and collects CO2 gas from exhaust gas generated by the melting and further reduction; a decarbonization refining unit that performs decarbonization refining by blowing the separated and collected CO2 gas into molten iron; and a measuring unit that measures the amount of CO gas generated during the decarbonization refining.

Low-grade raw materials (Fe content less than 67%) are input through the raw material input unit. High-quality raw materials account for a very small proportion of the total raw material supply, and due to concerns about limited supply and demand thereof, research is being conducted on ways to utilize low-quality raw materials, lower a reduction rate, reduce a yield due to increased gangue content, and the like.

The raw material reduction unit may reduce raw materials through a Direct Reduction Iron (DRI) process. Directly reduced iron may be broadly divided into three types: Direct Reduction Iron (DRI), Hot Briquetted Iron (HBI), and Iron Carbide. Among these, the most widely used is DRI, which is produced by reducing iron ore using denatured natural gas or directly inputting coal.

The melting unit may be performed through electric smelting (electric smelter). In order to solve problems such as a reduced reduction rate and a decreased yield due to an increased gangue content, which occur when using low-quality raw materials, hydrogen reduction direct reduction iron (DRI) and Electric Smelter (melting+implementation of further reduction by carbon material+carbon capture, utilization, and storage (CCUS) linkage) schemes instead of the electric furnace scheme are utilized. In this case, CO₂ or the like generated by the use of carbon reducing agents in an electric smelter process is likely to be reused in a decarbonization refining reaction, and thus CO₂ gas should be separately collected for use.

The collecting unit separates and collects CO₂ gas from exhaust gas generated according to the input of a carbon material. The separating and collecting of the CO₂ gas may be performed through physical adsorption or chemical absorption. However, the scheme is not limited thereto.

In the decarbonization refining unit, CO gas is generated as the separated and collected CO₂ gas is input into molten iron and undergoes decarbonization refining. After carbon and impurities are removed, CO₂ gas oxidizes Fe to produce FeO and Fe₂O₃, and in this case as well, CO gas continues to be generated.

The measuring unit may be performed by measuring the amount of CO gas generated in decarbonization refining and determining the end time of decarbonization. In conventional O₂ refining, CO gas is no longer generated at the end of decarbonization refining (2Fe+O₂→2FeO). However, in CO2 refining, even if decarbonization refining ends, CO gas continues to be generated during an oxidation process of metals such as Fe by CO2 gas, making it difficult to predict the end of decarbonization at a location at which CO gas generation stops (Fe+CO2→FeO+CO). Accordingly, it is possible to confirm that when refining is performed by blowing CO2 gas rather than O2 gas, a location at which the amount of CO gas generated changes, not a location at which CO gas generation stops, is a point at which decarbonization refining ends.

In an embodiment of the disclosure, a sample composition used was a carbon composition of pig iron used in a steelmaking process, and the composition is shown in Table 1.

TABLE 1
(wt %)

| Fe | C |
|---|---|
| 95.5% | 4.5% |

Thereafter, an analysis process was verified through the Factsage program and a lab-scale experiment was conducted in a vertical tube furnace. To simulate an actual process carried out in an open structure, an experiment was conducted using an open calculation mode of the Factsage program.

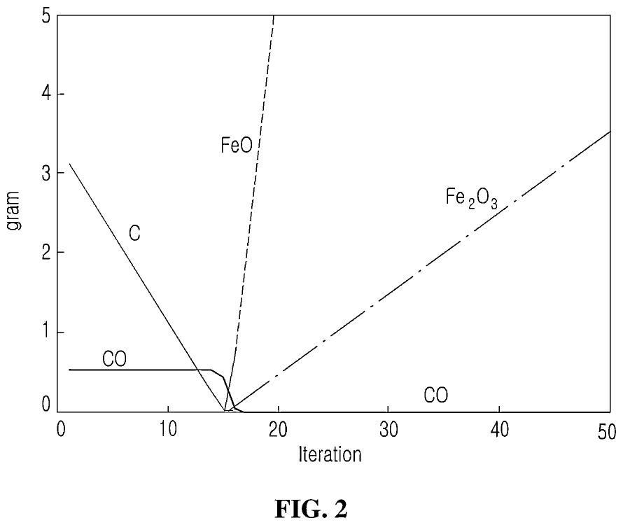

FIG. 2 is a graph of a result of a Factsage program for O₂ gas blowing.

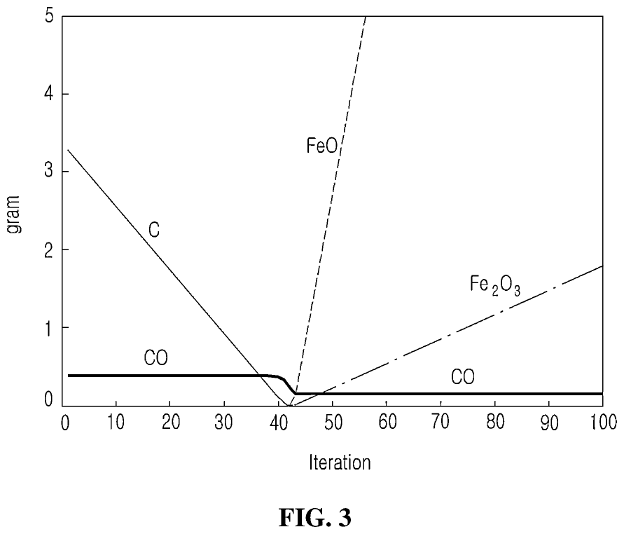

FIG. 3 is a graph of a result of a Factsage program for CO₂ gas blowing.

Referring to FIGS. 2 and 3, as a result of an experiment using the Factsage program, it is possible to confirm that when blowing in O₂ gas, carbon and impurities are removed, and then O₂ gas oxidizes Fe to produce FeO or Fe₂O₃. At this time, it is possible to confirm that the generation of CO gas stops. On the other hand, when CO₂ gas is blown, carbon and impurities are removed, and then CO₂ gas oxidizes Fe to produce FeO and Fe₂O₃. In this case, it is possible to confirm that the generation of CO gas is reduced as well, but there is a difference in that CO generation does not stop and continues to occur as in the case of O₂ gas.

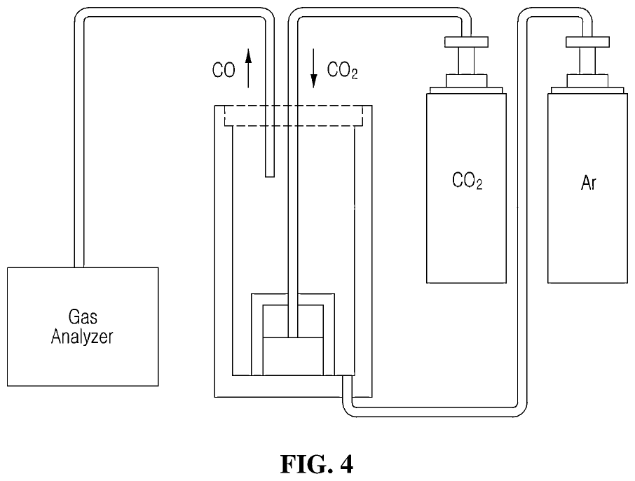

FIG. 4 is a schematic diagram of a vertical tubular furnace experiment used in an embodiment of the disclosure.

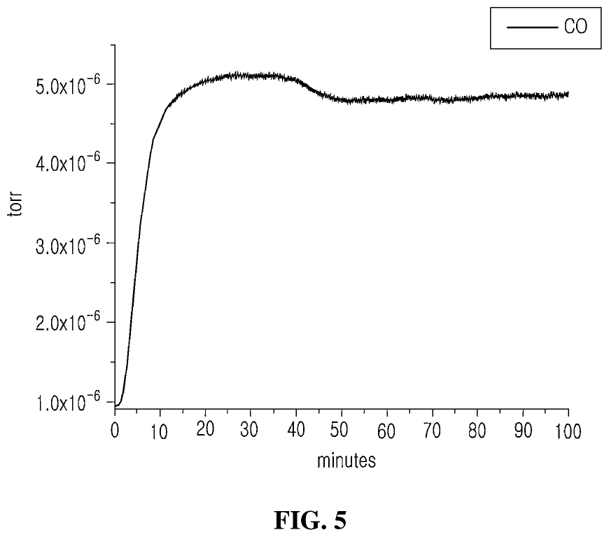

FIG. 5 is a graph of a gas analyzer analysis result in a vertical tube furnace for CO₂ gas blowing.

An experiment in a vertical tubular furnace was conducted through purging with Ar gas at the bottom and by immersing a CO₂ gas lance into molten iron from the top. Thereafter, CO gas coming out through the upper lance was observed using a gas analyzer.

Referring to FIGS. 4 and 5, it is possible to confirm that also from a result of observing CO gas generated from a vertical tube furnace using a gas analyzer, CO gas continues to be generated even after impurities are removed. Accordingly, it is possible to confirm that when refining is performed by blowing CO₂ gas rather than O₂ gas in a steelmaking process, a location at which the amount of CO gas generated changes, not a location at which CO gas generation stops, is a point at which decarbonization ends.

According to an embodiment of the disclosure, it is possible to achieve process optimization and carbon neutrality by collecting CO₂ gas generated from an electric smelter during melting and blowing the gas into molten iron during decarbonization refining.

This technology is intended to be applied to a process of refining carbon and impurities through CO₂ gas blowing to realize a carbon-neutral future steelmaking technology, rather than a process of refining carbon and impurities by blowing O₂ gas into molten iron in a general steelmaking process, and it is possible to predict the end of decarbonization refining by observing the amount of CO gas generated due to CO₂ gas blowing.

The description of the disclosure described above is for illustrative purposes, and those skilled in the art will understand that the disclosure is easily modifiable into other specific forms without changing the technical idea or essential features of the disclosure. Therefore, the examples described above should be understood in all respects as illustrative and not restrictive. For example, each component described as single may be implemented in a distributed manner, and similarly, components described as distributed may also be implemented in a combined form.

The scope of the disclosure is indicated by the claims described below, and all changes or modified forms derived from the meaning and scope of the claims and their equivalent concepts should be construed as being included in the scope of the disclosure.

What is claimed is:

1. A method for refining molten iron using hydrogen reduction DRI, the method comprising:
preparing a raw material;
reducing the raw material through a Direct Reduction Iron (DRI) process;
inputting a carbon material into the reduced raw material to perform melting and further reduction;
separating and collecting CO₂ gas from exhaust gas generated according to the input of the carbon material;
performing decarbonization refining by blowing the separated and collected CO₂ gas into molten iron; and
determining whether the decarbonization refining is completed by measuring an amount of CO gas generated in the decarbonization refining.

2. The method of claim 1, wherein the melting and further reduction are performed through electric smelting or by an electric smelter.

3. The method of claim 1, wherein the separating and collecting of the CO₂ gas are performed through physical adsorption or chemical absorption.

4. The method of claim 1, wherein the separating and collecting of the CO₂ gas comprise collecting CO₂ and O₂ mixed gas.

5. The method of claim 1, wherein the determining of whether the decarbonization refining is completed is achieved based on a location at which a reduction behavior of a CO gas generation amount occurs.

6. The method of claim 1, wherein the determining of whether the decarbonization refining is completed comprises performing further refining if the decarbonization refining is completed, and performing the decarbonization refining again if the decarbonization refining is not completed.

7. Molten iron obtained from the method for refining according to claim 1.

8. A system device for refining molten iron using hydrogen reduction DRI, the system device comprising:
a raw material input unit to input a raw material;
a raw material reduction unit to reduce the raw material;
a melting unit to melt and further reduce the reduced raw material;
a collecting unit to separate and collect CO₂ gas from exhaust gas generated by the melting and further reduction;
a decarbonization refining unit to perform decarbonization refining by blowing the separated and collected CO₂ gas into molten iron; and
a measuring unit to measure an amount of CO gas generated during the decarbonization refining.

9. The system device of claim 8, wherein the raw material reduction unit is configured to reduce a raw material through a Direct Reduction Iron (DRI) process.

10. The system device of claim 8, wherein the melting is performed through electric smelting or by an electric smelter.

11. The system device of claim 8, wherein the measuring unit is configured to measure the amount of CO gas generated in decarbonization refining and to determine an end time of decarbonization.
